(19) United States
(12) Patent Application Publication
(10) Pub. No.: US 2013/0344224 A1
(43) Pub. Date: Dec. 26, 2013

(54) CARBONATION RETENTION AGENT FOR ALCOHOL-CONTAINING CARBONATED BEVERAGE

(71) Applicants: Hiroko Yano, Izumisano-shi (JP); Mizuho Iwano, Izumisano-shi (JP)

(72) Inventors: Hiroko Yano, Izumisano-shi (JP); Mizuho Iwano, Izumisano-shi (JP)

(73) Assignee: FUJI OIL COMPANY LIMITED, Osaka-shi, Osaka (JP)

(21) Appl. No.: 14/003,156

(22) PCT Filed: Mar. 15, 2012
(86) PCT No.: PCT/JP2012/056728

§ 371 Date: Sep. 4, 2013

(30) Foreign Application Priority Data
Mar. 18, 2011 (JP) 2011-059983

(51) Int. Cl. C12G 3/04

(52) U.S. Cl. CPC C12G 3/04
USPC 426/592; 536/123.1

(57) ABSTRACT

[Problem] Provided is a material that is capable of suppressing the loss of carbonation in an alcohol-containing carbonated beverage over time to reduce changes in flavor, including mouthfeel, when drinking the beverage. [Solution] Addition of a water-soluble soybean polysaccharide into an alcohol-containing carbonated beverage that contains distilled liquor, not fermented liquor, as the alcohol source and does not contain any milk protein material suppresses the loss of carbonation over time to retain carbonation in the carbonated beverage for a long period of time, thereby reducing changes in flavor during a period from immediately after opening the container thereof to when drinking the beverage after storage.

### TECHNICAL FIELD

The present invention relates to a carbonation retention agent for an alcohol-containing carbonated beverage that is capable of retaining carbonation in a carbonated beverage for a long period of time to reduce changes in flavor, including mouthfeel, when drinking the carbonated beverage.

### BACKGROUND ART

Carbonated beverages are widely consumed as beverages whose refreshing mouthfeel is enjoyed when ingested, and alcohol-containing carbonated beverages such as beer, beer-taste sparkling alcoholic drink, beer-taste sparkling alcoholic drink containing no malt (also called third beer in Japanese), and chuhai (shochu-based beverage) are so widely distributed.

Carbonated beverages can be more deliciously drunk by providing a refreshing feeling unique to sparkling carbonation and also by enhancing taste of the beverages with stimulation from the sparkling carbonation. Such a refreshing feeling and flavor depend on the amount of carbonation contained and, when carbonation in the carbonated beverages decreases, such a refreshing feeling is less likely to be felt and the effect of enhancing the taste of the beverages decreases.

For example, when an alcohol-containing carbonated beverage filled in a container such as a can is poured into a cup to be drunk, a refreshing feeling can be obtained immediately after poring it, but there is a problem in that carbonation will be lost soon and the refreshing feeling will be less likely to be felt, whereby the beverage cannot be drunk deliciously.

Examples of a method for preventing the loss of carbonation over time includes a method in which fine bubbles of carbon dioxide are generated and fed into a liquid for beverage (Patent Literature 1). This method lacks versatility in that a special machine is required and a manufacturing process of the beverage becomes complicated.

A technique of giving beer-like foam generating characteristics to mixed liquor by making the mixed liquor to contain a saponin component and carbonation (Patent Literature 2) and a technique of using pea protein as a substance for improving foam generation and foam stability of a beer-taste sparkling alcoholic beverage (Patent Literature 3) are disclosed. However, there is a problem of bitter taste of saponin in Patent Literature 2 and, in Patent Literature 3, a protein-based foaming agent is used at a content of no less than 0.5% in the carbonated beverage, so that there is concern about negative influence on the flavor in both cases and a technique for further improving the flavor is desired.

### CITATION LIST

### Patent Literature

[Patent Literature 1] Japanese Patent Application Laid-Open Publication No. 2009-100705

[Patent Literature 2] Japanese Patent Application Laid-Open Publication No. 61-88869

[Patent Literature 3] Japanese Patent Application Laid-Open Publication No. 2005-323585

### SUMMARY OF INVENTION

### Technical Problem

In view of the background described above, an object of the present invention is to provide a material that is capable of suppressing the loss of carbonation in an alcohol-containing carbonated beverage over time to reduce changes in flavor, including mouthfeel, when drinking the beverage.

### Solution to Problem

As a result of intensive studies on the above problems, the inventors of the present invention have found that, exclusively into an alcohol-containing carbonated beverage that contains distilled liquor, not fermented liquor, as the alcohol source and does not contain any milk protein material out of various alcohol-containing carbonated beverages, addition of a water-soluble soybean polysaccharide can suppress the loss of carbonation over time to retain carbonation in the carbonated beverage for a long period of time, thereby reducing changes in flavor during a period from immediately after opening the container thereof to when drinking the beverage after storage. Thus, the inventors have solved the problems by the present invention.

That is, the present invention is:

(1) A carbonation retention agent for an alcohol-containing carbonated beverage that contains distilled liquor, not fermented liquor, as the alcohol source and does not contain any milk protein material, the carbonation retention agent comprising a water-soluble soybean polysaccharide.
(2) A method for retaining carbonation in an alcohol-containing carbonated beverage that contains distilled liquor, not fermented liquor, as the alcohol source and does not contain any milk protein material, the method comprising adding a water-soluble soybean polysaccharide in manufacturing the alcohol-containing carbonated beverage.
(3) A method for manufacturing an alcohol-containing carbonated beverage that contains distilled liquor, not fermented liquor, as the alcohol source and does not contain any milk protein material, the method comprising adding a water-soluble soybean polysaccharide.
(4) Use of a water-soluble soybean polysaccharide as a carbonation retention agent for an alcohol-containing carbonated beverage that contains distilled liquor, not fermented liquor, as the alcohol source. and does not contain any milk protein material.
(5) The carbonation retention agent for an alcoholic-containing carbonated beverage according to (1), wherein fruit, fruit juice, vegetable juice, or tea extract is added into the alcoholic-containing carbonated beverage.
(6) The method for retaining carbonation in an alcohol-containing carbonated beverage according to (2), wherein fruit, fruit juice, vegetable juice, or tea extract is added into the alcoholic-containing carbonated beverage.
(7) The method for manufacturing an alcohol-containing carbonated beverage according to (3), wherein fruit, fruit juice, vegetable juice, or tea extract is added into the alcoholic-containing carbonated beverage.
(8) The method for retaining carbonation in an alcohol-containing carbonated beverage according to (2), wherein an additive content of the water-soluble soybean polysaccharide is 0.005 to 0.5 wt % in the alcohol-containing carbonated beverage.
(9) The method for manufacturing an alcohol-containing carbonated beverage according to (3), wherein an additive content of the water-soluble soybean polysaccharide is 0.005 to 0.5 wt % in the alcohol-containing carbonated beverage.

### Advantageous Effects of Invention

A product of the present invention is capable of suppressing the loss of carbonation over time exclusively in a specific alcohol-containing carbonated beverage that contains distilled liquor, not fermented liquor, as the alcohol source and does not contain any milk protein material, thereby reducing changes in flavor, including mouthfeel, when drinking the beverage. With the present invention, even when time passes after opening a container containing the carbonated beverage, it is possible to drink the carbonated beverage with a refreshing feeling.

### DESCRIPTION OF EMBODIMENTS

### Water-Soluble Soybean Polysaccharide

A water-soluble soybean polysaccharide is a polysaccharide that is derived from a soybean and can dissolve in water. The water-soluble soybean polysaccharide can be obtained by manufacturing methods described below, for example.

### Raw Material of Water-Soluble Soybean Polysaccharide

A raw material of the water-soluble soybean polysaccharide contained in a carbonation retention agent of the present invention is preferably derived from soybean cotyledon, for which okara (soybean residue) that is a by-product in producing tofu (soybean curd) or soybean protein isolate, for example, can be used. When fat-containing okara is used, flavor deterioration due to oxidation by heating oil contained therein may occur. Thus, it is preferable to use okara obtained from defatted soybean, and it is most preferable to use okara that is produced as a by-product in a step of manufacturing soybean protein isolate.

### Method for Manufacturing Water-Soluble Soybean Polysaccharide

The water-soluble soybean polysaccharide can be obtained, for example, by adding water to okara that is produced as a by-product at the step of manufacturing soybean protein isolate, then separating a slurry thermally extracted at a temperature over 100° C. into solid and liquid phases with a centrifuge, and purifying and drying the supernatant.

As a pH value for the heat treatment of the okara, a pH from 3 to 7 inclusive is preferable, and a pH greater than 4 and equal to or less than 6 is more preferable. Flavor or color may deteriorate when the pH is excessively high, and the water-soluble soybean polysaccharide may be excessively degraded into small molecules when the pH is excessively low. In such cases, the effect of the present invention undesirably decreases.

The heating temperature is preferably higher than 100° C., and more preferably equal to or lower than 130° C. The extraction rate of the water-soluble soybean polysaccharide may decrease when the temperature is excessively low. The water-soluble soybean polysaccharide may be excessively degraded into small molecules when the temperature is excessively high. In such cases, the effect of the present invention undesirably decreases.

### Sterilization

It is desirable that the obtained water-soluble soybean polysaccharide be sterilized at the time of manufacture as necessary. Any type of method can be used for the sterilization, and examples of the method include high-temperature sterilization such as UHT sterilization; retort sterilization, electromagnetic sterilization, high-temperature vacuum sterilization, ozone sterilization, electrolyzed water sterilization, and indirect heating sterilization.

### Drying

It is desirable that the obtained water-soluble soybean polysaccharide be dried as necessary. Known methods can be used for this drying, and examples thereof include a freeze-drying method, a spray drying method, a shelf drying method, a drum drying method, a belt drying method, a fluidized-bed drying method, and a microwave drying method. The water content after the drying is desired to be 10 wt % or less in terms of preservability.

### Carbonation Retention Agent

The carbonation retention agent for an alcohol-containing carbonated beverage that contains only distilled liquor, not fermented liquor, as the alcohol source and does not contain any milk protein material in the present invention means one that is capable of suppressing the loss of carbonation in the alcohol-containing carbonated beverage over time after opening the container thereof to reduce changes in flavor, including mouthfeel, when drinking the beverage.

In the present invention, the effect of suppressing the loss of carbonation in the alcohol-containing carbonated beverage over time after opening the container thereof is evaluated in terms of a sparkling feeling and a sparkling persistent feeling. The sparkling feeling herein is an index for evaluating a feeling of stimulation caused by sparkling carbonation immediately after drinking a carbonated beverage, and the sparkling persistent feeling is an index for evaluating persistence of a feeling of stimulation by sparkling carbonation remaining on the tongue after drinking the carbonated beverage.

In other words, an alcohol-containing carbonated beverage that provides a more intense feeling of stimulation by sparkling carbonation and longer persistence of the feeling of stimulation by sparkling carbonation is considered to have a better sparkling feeling and better sparkling persistent feeling, and thus is more preferable.

### Distilled Liquor

The alcohol-containing carbonated beverage that contains distilled liquor, not fermented liquor, as the alcohol source and does not contain any milk protein material in the present invention will be described. The distilled liquor contained as the alcohol source is a liquor that has undergone a distillation process, and examples thereof include multiply distilled shochu, single distilled shochu, whiskey, brandy, vodka, rum, tequila, liqueur, and spirits. In other words, the distilled liquor is a liquor whose nonvolatile components are removed by distillation after undergoing a fermentation process and in which these components are hardly contained.

### Alcohol-Containing Carbonated Beverage

The present invention can be effectively used for alcohol-containing carbonated beverages using the above-described distilled liquor as the alcohol source. Various non-fermented components can be added to the distilled liquor, and examples thereof include substances or extracts derived from plants such as fruit, fruit juice, vegetable juice, and tea extract, saccharides such as sugar, muscovado, fructose-glucose syrup, and maltose, various vitamins, colors, and flavors. Because the distilled liquor itself does not have sparkling characteristics, the liquor needs to be diluted with another beverage having sparkling characteristics or subjected to a carbonation process.

### Added Fruit Juice, etc.

As fruit juice that can be used in the present invention, for example, a fruit extract liquid that is extracted from raw fruits by squeezing can be used. The fruit juice is classified into concentrated fruit juice and straight fruit juice. Among concentrated fruit juices, a concentrated fruit juice that is prepared by both cut back (addition of straight fruit juice) and flavor reconstitution (addition of flavor) is the most excellent in flavor as a raw ingredient for the fruit juice. Examples of the straight fruit juice include unsterilized fruit juice, sterilized fruit juice, and sterilized frozen fruit juice. The content of fruit juice is not particularly limited, but is 0.1 to 50 wt %, for example.

Species of fruits as a raw ingredient to be used for the fruit juice is not particularly limited, and examples thereof include citrus fruits such as lemon, grapefruit, lime, orange, Satsuma orange, mandarin, and tangerine, apple, peach, Japanese apricot, melon, strawberry, banana, grapes, pineapple, mango, papaya, passionfruit, guava, acerola, pear, apricot, lychee, cassis, European pear, and plum, and one or two or more of these can be used.

### Fermented Liquor

The fermented liquor herein is a liquor that does not undergo a distillation process, and examples thereof include beer, wine, sake, Huangjiu (Chinese rice wine), beer-taste sparkling alcoholic drink having a low malt content, and beer-taste sparkling alcoholic drink containing no malt (also called third beer in Japanese). These liquors contain various fermentation products generated in a fermentation process, and the fermentation products contain various nonvolatile components. In the present invention, it has been found that the presence of fermentation products generated during the fermentation process reduces the effect of the invention, and the factor thereof is considered to be nonvolatile components contained in the fermentation products as described later. Accordingly, in the present invention, it is important to exclude the fermented liquor.

Note that the effect of the present invention cannot be obtained for liquors such as sherry, port wine, or beer-taste sparkling alcoholic drink that has a low malt content, and contains liqueur (also called fourth beer in Japanese), in which fermented liquor is mixed with distilled liquor, because fermentation products generated during the fermentation process are mixed thereinto.

The alcohol-containing carbonated beverage of the present invention is also characterized in containing no milk protein material. The milk protein material can be obtained from milk of mammals such as cow milk, goat milk, and human milk, and example thereof include whole milk, whole milk powder, skim milk, skim milk powder, whey; concentrated milk, milk reconstituted from concentrated milk, and dried powder thereof; and unsweetened condensed milk and sweetened condensed milk based on cow milk, for example. In the present invention, beverages directly using these milk protein materials are not included, and materials prepared by lactic fermentation of these materials with lactic acid bacteria, for example are not included either. It is because the presence of milk protein is considered to become a factor inhibiting the effect of the present invention as described later.

Examples of the alcohol-containing carbonated beverage that contains distilled liquor, not fermented liquor, as the alcohol source, and does not contain any milk protein material as recited above include chuhai in which shochu is diluted with fruit juice or tea extract, highball, and whiskey and coke.

### Method for Manufacturing Alcohol-Containing Carbonated Beverage

As a method for obtaining a carbonated beverage into which the carbonation retention agent of the present invention is made to be contained, commonly used methods can be used. For example, a canned chuhai can be manufactured by mixing specified amounts of distilled liquor, water, carbonation retention agent, fruit juice, and sugars, for example, then making carbonation with a carbonator, charging a container with the resultant liquid, and performing heating sterilization after sealing the container. The carbonation retention agent may be added at any timing in the manufacturing process, and may be added after the carbonation. Carbonated water may also be added after preparing the above-described raw material liquid in a concentrated state. The whiskey and coke can be prepared by adding carbonated water separately prepared to whiskey or performing a carbonation process after diluting whiskey with water.

In the present invention, within a range in which the effect of a product of the present invention is not affected, other emulsifiers or stabilizers can be used as appropriate.

### Effects

When the alcohol-containing carbonated beverage prepared by the above-described method is poured into a container such as a cup, the sparkling feeling and the sparkling persistent feeling will be excellent and thus mouthfeel will be good at least for 60 minutes.

The reason why the present invention has no effect on an alcohol-containing carbonated beverage containing fermented liquor is considered as follows, though it is purely speculation. Sparkling fermented liquor such as beer, low-malt beer, or third beer contains proteins having large molecules derived from malt or pea that is present in raw materials or various nonvolatile components such as bitter substances derived from hops. These nonvolatile components are contained in fermentation products generated during a fermentation process, and characteristics thereof are changed by the fermentation process, so that the nonvolatile components exhibit enhanced foaming properties.

Combination of these components with carbonation in liquid generates creamy foam to form a foam layer on the top surface of the beverage. However, as the water-soluble soybean polysaccharide contributes to the stability of this foam, the effect of the water-soluble soybean polysaccharide on retaining bubbles of carbonation in the carbonated beverage is considered to be reduced accordingly. In addition, for distilled liquor such as fourth beer into which fermented liquor is mixed, influence of the nonvolatile components generated during the fermentation process is significant, and thus the effect of the water-soluble polysaccharide is considered to be reduced in the same manner.

By contrast, in a carbonated beverage such as chuhai using no fermented liquor, proteins after undergoing a fermentation process or substances derived from hops are not present, and a foam layer is unlikely to be formed on the top surface of the beverage. Accordingly, unlike in the case of the beverage containing fermented liquor, it is considered that the water-soluble soybean polysaccharide does not contribute to the stability of foam on the top surface of the beverage, and thus the effect of retaining bubbles in the carbonated beverage can be obtained.

For an alcohol-containing carbonated beverage containing a milk protein material, the effect of the present invention cannot be obtained either. The reason therefor is because it is considered that as the water-soluble soybean polysaccharide contributes to dispersion stabilization of milk proteins in the beverage, the effect of retaining bubbles of carbonation in the carbonated beverage containing the water-soluble soybean polysaccharide is reduced accordingly, though it is purely speculation.

The additive amount of the carbonation retention agent of the present invention in the carbonated beverage is preferably 0.005 to 0.5 wt %, and more preferably 0.01 to 0.1 wt % in solid content. The effect may be insufficient when the additive amount is small, and an excessively large amount may make no difference in the effect and also may adversely affect the flavor.

### Method for Evaluating Alcohol-Containing Carbonated Beverage

The effect of suppressing the loss of carbonation over time in an alcohol-containing carbonated beverage obtained by the present invention is evaluated by sensory evaluation. This sensory evaluation is performed by comprehensively evaluating a sparkling feeling and a sparkling persistent feeling.

### Method for Sensory Evaluation

Specifically, the sensory evaluation is performed as follows: a carbonated beverage is prepared by adding the carbonation retention agent of the present invention, and the sparkling feeling and the sparkling persistent feeling are evaluated on the carbonated beverage immediately after the preparation (0 minute) and on the carbonated beverage that was slowly poured in a cup and stored therein at 20° C. for 60 minutes. Assuming that the sparkling feeling and the sparkling persistent feeling on a carbonated beverage without an additive immediately after preparation (0 minute) each are set to 5 points, the sparkling feeling and the sparkling persistent feeling on each carbonated beverage immediately after preparation (0 minute) and on the carbonated beverage stored for 60 minutes are evaluated by four panelists on a scale of 1 to 5 points, and results thereof are averaged. As the sparkling feeling is more intense and as the sparkling feeling persists longer, the point is higher. Subsequently, the difference between a value for the carbonated beverage stored for 60 minutes and a value for the carbonated beverage immediately after preparation (0 minute) is calculated. The sum of differences calculated on the sparkling feeling and the sparkling persistent feeling each is determined to be a sensory evaluation. More specifically, the sensory rating is calculated by the following formula.

Sensory evaluation (point)=(Average of sparkling feeling 60 minutes after preparation−Average of sparkling feeling immediately after preparation (0 minute))+(Average of sparkling persistent feeling 60 minutes after preparation−Average of sparkling persistent feeling immediately after preparation (0 minute))

If this sensory evaluation point is −3.5 points or higher, the carbonated beverage is considered to be able to maintain the sparkling feeling and the sparkling persistent feeling, and is judged to be passed.

### EXAMPLES

Examples will be described hereinafter. In the examples, all parts and percentages are based on weight.

### Example of Manufacturing Water-Soluble Soybean Polysaccharide

The pH of a slurry in which two part of water was added to one part of okara produced as a by-product at a step of manufacturing soybean protein isolate was adjusted at 5.0 with hydrochloric acid, and the slurry was heated in an autoclave at 120° C. for 1.5 hours. The slurry thus heated was centrifuged (at 5000×g) with a centrifuge, and the supernatant was obtained. After the supernatant was purified, a water-soluble soybean polysaccharide A was obtained by freeze-drying.

### Chuhai

### Example 1

From 350 grams of commercially available alcohol-containing carbonated beverage in a can (Product name: Kirin Chu-hi Hyoketsu Lemmon, manufactured by Kirin Brewery Co., Ltd.), 65 grams of the alcohol-containing carbonated beverage was removed. In place thereof, 15 grams of 1% aqueous solution of the water-soluble soybean polysaccharide A was added, totaling 300 grams. The can was slowly moved to make the solution uniform, and thus a carbonated beverage containing the carbonation retention agent of the present invention was obtained.

### Comparative Example 1

The same preparation as that in Example 1 was used other than adding 15 grams of water instead of the aqueous solution of the water-soluble soybean polysaccharide.

### Results

TABLE 1
Sensory Evaluation of Chuhai

| | | | | Sparkling | | |
|---|---|---|---|---|---|---|
| | | Sparkling | | persistent | | |
| | | feeling | | feeling | | Sensory |
| | | | Difference | | Difference | evaluation |
| | | | from 0 min | | from 0 min | point |
| | | | (a) | | (b) | (a + b) |
| Example 1 | 0 min | 5 | — | 5 | — | — |
| | 30 min | 4 | −1 | 4 | −1 | −2 |
| | 60 min | 3.2 | −1.8 | 4 | −1 | −2.8 |
| Comparative | 0 min | 5 | — | 5 | — | — |
| Example 1 | 30 min | 3 | −2 | 3 | −2 | −4 |
| | 60 min | 2 | −3 | 2 | −3 | −6 |

As indicated by the results in Table 1, in Example 1 where the water-soluble soybean polysaccharide was added, the point of the sensory evaluation 60 minutes later after pouring the carbonated beverage into the cup was −2.8 points, judged to be passed. In contrast, in Comparative Example 1 where the water-soluble soybean polysaccharide was not added, the point of the sensory evaluation was −6 points, which was an inferior result.

### Chuhai

### Example 2

From 350 grams of commercially available alcohol-containing carbonated beverage in a can (Product name: Strong Zero Double Grapefruit, manufactured by Suntory Liquors Limited), 65 grams of the alcohol-containing carbonated beverage was removed. In place 1.5 thereof, 15 grams of 1% aqueous solution of the water-soluble soybean polysaccharide A was added, totaling 300 grams. The can was slowly moved to make the solution uniform, and thus a carbonated beverage containing the carbonation retention agent of the present invention was obtained.

TABLE 2
Sensory Evaluation of Chuhai

| | | | | Sparkling | | |
|---|---|---|---|---|---|---|
| | | Sparkling | | persistent | | |
| | | feeling | | feeling | | Sensory |
| | | | Difference | | Difference | evaluation |
| | | | from 0 min | | from 0 min | point |
| | | | (a) | | (b) | (a + b) |
| Example 2 | 0 min | 4.5 | — | 5 | — | — |
| | 30 min | 4 | −0.5 | 4 | −1 | −1.5 |
| | 60 min | 3.8 | −0.7 | 3.2 | −1.8 | −2.5 |
| Comparative | 0 min | 5 | — | 5 | — | — |
| Example 2 | 30 min | 3 | −2 | 3 | −2 | −4 |
| | 60 min | 2.3 | −2.7 | 1.7 | −3.3 | −6 |

As indicated by the results in Table 2, in Example 2 where the water-soluble soybean polysaccharide was added, the point of the sensory evaluation 60 minutes later after pouring the carbonated beverage into the cup was −2.5 points, judged to be passed. In contrast, in Comparative Example 2 where the water-soluble soybean polysaccharide was not added, the point of the sensory evaluation was −6 points, which was an inferior result. By adding the water-soluble soybean polysaccharide as in Examples 1 and 2, a carbonated beverage could be prepared that could maintain the sparkling feeling and the sparkling persistent feeling of the carbonated beverage after being poured into the cup and suppress the loss of carbonation over time to provide a refreshing feeling.

### Fourth Beer

### Comparative Example 3

From 350 grams of commercially available alcohol-containing carbonated beverage in a can (Product name: Kinmugi, manufactured by Suntory Liquors Limited), 65 grams of the alcohol-containing carbonated beverage was removed. In place thereof, 15 grams of 1% aqueous solution of the water-soluble soybean polysaccharide A was added, totaling 300 grams. The can was slowly moved to make the solution uniform, and thus a carbonated beverage was obtained.

### Comparative Example 4

The same preparation as that in Comparative Example 3 was used other than adding 15 grams of water instead of the aqueous solution of the water-soluble soybean polysaccharide.

TABLE 3
Sensory Evaluation of Fourth Beer

| | | | | Sparkling | | |
|---|---|---|---|---|---|---|
| | | Sparkling | | persistent | | |
| | | feeling | | feeling | | Sensory |
| | | | Difference | | Difference | evaluation |
| | | | from 0 min | | from 0 min | point |
| | | | (a) | | (b) | (a + b) |
| Comparative | 0 min | 4.5 | — | 5 | — | — |
| Example 3 | 30 min | 3.5 | −1 | 3 | −2 | −3 |
| | 60 min | 2.5 | −2 | 2 | −3 | −5 |
| Comparative | 0 min | 5 | — | 5 | — | — |
| Example 4 | 30 min | 3 | −2 | 3 | −2 | −4 |
| | 60 min | 2.5 | −2.5 | 1.7 | −3.3 | −5.8 |

As indicated by the results in Table 3, in Comparative Example 3 where the water-soluble soybean polysaccharide was added into the fourth beer, the point of the sensory evaluation 60 minutes later after pouring the carbonated beverage into the cup was −5 points, thus the result of the sensory evaluation was inferior.

### Beer

### Comparative Example 5

From 350 grams of commercially available alcohol-containing carbonated beverage in a can (Product name: YEBISU BEER, manufactured by Sapporo Breweries Limited), 65 grams of beer was removed. In place thereof, 15 grams of 1% aqueous solution of the water-soluble soybean polysaccharide A was added, totaling 300 grams. The can was slowly moved to make the solution uniform, and thus a carbonated beverage was obtained.

### Comparative Example 6

The same preparation as that in Comparative Example 5 was used other than adding 15 grams of water instead of the aqueous solution of the water-soluble soybean polysaccharide.

TABLE 4
Sensory Evaluation of Beer

| | | | | Sparkling | | |
|---|---|---|---|---|---|---|
| | | Sparkling | | persistent | | |
| | | feeling | | feeling | | Sensory |
| | | | Difference | | Difference | evaluation |
| | | | from 0 min | | from 0 min | point |
| | | | (a) | | (b) | (a + b) |
| Comparative | 0 min | 5 | — | 5 | — | — |
| Example 5 | 30 min | 3 | −2 | 2.5 | −2.5 | −4.5 |
| | 60 min | 2 | −3 | 2 | −3 | −6 |
| Comparative | 0 min | 5 | — | 5 | — | — |
| Example 6 | 30 min | 3 | −2 | 2 | −3 | −5 |
| | 60 min | 1.3 | −3.7 | 1.7 | −3.3 | −7 |

As indicated by the results in Table 4, in Comparative Example 5 where the water-soluble soybean polysaccharide was added into the beer, the point of the sensory evaluation 60 minutes later after pouring the carbonated beverage into the cup was −6 points, thus the result of the sensory evaluation was inferior.

As described above, it has been found that the effect of retaining carbonation of the present invention cannot be obtained when the water-soluble soybean polysaccharide is added into fourth beer, in which fermented liquor is mixed with distilled liquor, or into beer as fermented liquor.

### Alcohol-Containing Carbonated Beverage Containing Milk Protein Material

### Comparative Example 7

From 350 grams of commercially available alcohol-containing carbonated beverage in a can (Product name: Yogur-Sour, manufactured by Japan Sangaria Beverage Co., Ltd.), 65 grams of the alcohol-containing carbonated beverage was removed. In place thereof, 15 grams of 1% aqueous solution of the water-soluble soybean polysaccharide A was added, totaling 300 grams. The can was slowly moved to make the solution uniform, and thus a carbonated beverage was obtained.

### Comparative Example 8

The same preparation as that in Comparative Example 7 was used other than adding 15 grams of water instead of the aqueous solution of the water-soluble soybean polysaccharide.

TABLE 5

| | | | | Sparkling | | |
|---|---|---|---|---|---|---|
| | | Sparkling | | persistent | | |
| | | feeling | | feeling | | Sensory |
| | | | Difference | | Difference | evaluation |
| | | | from 0 min | | from 0 min | point |
| | | | (a) | | (b) | (a + b) |
| Comparative | 0 min | 5 | — | 5 | — | — |
| Example 7 | 30 min | 3.5 | −1.5 | 3 | −2 | −3.5 |
| | 60 min | 2 | −3 | 1.5 | −3.5 | −6.5 |
| Comparative | 0 min | 5 | — | 5 | — | — |
| Example 8 | 30 min | 3 | −2 | 2.5 | −2.5 | −4.5 |
| | 60 min | 2 | −3 | 1.5 | −3.5 | −6.5 |

As indicated by the results in Table 5, the sensory evaluation point of Comparative Example 7 where the water-soluble soybean polysaccharide was added was −6.5 points, which was an inferior result. As described above, it has been found that the effect of retaining carbonation of the present invention cannot be obtained when the water-soluble soybean polysaccharide is added into an alcohol-containing carbonated beverage containing a milk protein material.

### Industrial Applicability

By adding a water-soluble soybean polysaccharide, it is possible to suppress the loss of carbonation in an alcohol-containing carbonated beverage over time, and this effect can reduce changes in flavor, including mouthfeel, when drinking the beverage. With the present invention, even when time passes after opening a container of an alcohol-containing carbonated beverage, it is possible to drink the alcohol-containing carbonated beverage with a refreshing feeling.

1. A carbonation retention agent for an alcohol-containing carbonated beverage that contains distilled liquor, not fermented liquor, as an alcohol source and does not contain any milk protein material, the carbonation retention agent comprising:
a water-soluble soybean polysaccharide.

2. A method for retaining carbonation in an alcohol-containing carbonated beverage that contains distilled liquor, not fermented liquor, as an alcohol source and does not contain any milk protein material, the method comprising:
adding a water-soluble soybean polysaccharide in manufacturing the alcohol-containing carbonated beverage.

3. A method for manufacturing an alcohol-containing carbonated beverage that contains distilled liquor, not fermented liquor, as an alcohol source and does not contain any milk protein material, the method comprising:
adding a water-soluble soybean polysaccharide.

4. Use of a water-soluble soybean polysaccharide as a carbonation retention agent for an alcohol-containing carbonated beverage that contains distilled liquor, not fermented liquor, as an alcohol source and does not contain any milk protein material.

5. The carbonation retention agent for an alcoholic-containing carbonated beverage according to claim 1, wherein fruit, fruit juice, vegetable juice, or tea extract is added into the alcoholic-containing carbonated beverage.

6. The method for retaining carbonation in an alcohol-containing carbonated beverage according to claim 2, wherein fruit, fruit juice, vegetable juice, or tea extract is added into the alcoholic-containing carbonated beverage.

7. The method for manufacturing an alcohol-containing carbonated beverage according to claim 3, wherein fruit, fruit juice, vegetable juice, or tea extract is added into the alcoholic-containing carbonated beverage.

8. The method for retaining carbonation in an alcohol-containing carbonated beverage according to claim 2, wherein an additive content of the water-soluble soybean polysaccharide is 0.005 to 0.5 wt % in the alcohol-containing carbonated beverage.

9. The method for manufacturing an alcohol-containing carbonated beverage according to claim 3, wherein an additive content of the water-soluble soybean polysaccharide is 0.005 to 0.5 wt % in the alcohol-containing carbonated beverage.
